(19) United States
(12) Patent Application Publication
(10) Pub. No.: US 2006/0223430 A1
(43) Pub. Date: Oct. 5, 2006

(54) Register for air conditioning

(75) Inventors: Minoru Shibata, Aichi-ken (JP); Masanobu Muto, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/386,721

(22) Filed: Mar. 23, 2006

(30) Foreign Application Priority Data
Dec. 1, 2005 (JP) 2005-348068
Mar. 31, 2005 (JP) 2005-103244

(51) Int. Cl. B60H 1/34

(52) U.S. Cl. 454/155

(57) ABSTRACT

An air-conditioning register includes a register panel, and a cylinder-shaped retainer. The register panel is disposed in a vehicle passenger room, and has an outlet opening for air-conditioning air. The retainer demarcates a ventilation passage communicated with the outlet opening of the register panel, and has an inner opposite end and a register-panel-side opposite end. The register-panel-side opposite end of the retainer includes at least one member selected from the group consisting of a top-surface wall, a bottom-surface wall and paired side-surface walls, which demarcates a surface of the ventilation passage, and which is disposed movably so as to make the surface movable between diminishing the ventilation passage and enlarging the ventilation passage adjacent to the outlet opening of the register panel.

### BACKGROUND OF THE INVENTION

1. Field of the Invention

The present invention relates to a register for air conditioning. In particular, it relates to an air-conditioning register, which exhibits good directivity in terms of the direction for blowing out air-conditioning air.

2. Description of the Related Art

In a vehicle, an air conditioner prepares air-conditioning air, and blows out the prepared air-conditioning air into a vehicle passenger room to control the temperature in the vehicle passenger room. The air-conditioning air is blown out into the vehicle passenger room by way a register for air conditioning, which is disposed in the vehicle passenger room. A general air-conditioning register comprises a register panel, a cylinder-shaped retainer, a plurality of vertical blades, and a plurality of horizontal blades. The register panel has an outlet opening. The retainer has a ventilation passage, which is communicated with the outlet opening of the register panel. The vertical blades and horizontal blades are supported and accommodated swingably in the retainer. An operator adjusts the directions of the vertical blades and horizontal blades in order to blow air-conditioning air in desired directions.

Japanese Unexamined Utility Model Publication (KOKAI) No. 63-185,047 and Japanese Unexamined Utility Model Publication (KOKAI) No. 2-24,232 disclose such conventional air-conditioning registers, for instance.

In a conventional air-conditioning register disclosed in Japanese Unexamined Utility Model Publication (KOKAI) No. 63-185,047, the side walls of the casing (or retainer), which demarcate the ventilation passage, are curved, that is, they are formed as a shape which enlarges diametrically from the state of being diametrically reduced from the vehicle front side to the vehicle rear side, respectively; and at the same time the fins (or blades), which are disposed most adjacent to the side walls are curved as well. Since the conventional air-conditioning register disclosed in the utility model publication has the curved side walls and the curved fins, it can blow out air-conditioning air in the direction along the curved shapes, that is, in the direction getting away from the center of the outlet opening.

A conventional air-conditioning register disclosed in Japanese Unexamined Utility Model Publication (KOKAI) No. 2-24,232 comprises a plurality of blowing-direction deflector plates (or blades) which are bendable. Since the conventional air-conditioning register disclosed in the utility model publication further comprises a connector member which connects the blow-direction deflector plates, it can keep the bent state of the blowing-direction deflector plates securely. Accordingly, the conventional air-conditioning register can blow out air-conditioning air in the direction along the bent direction of the blowing-direction deflector plates.

Meanwhile, not only the external appearance of vehicle has been upgraded, but also the decorativeness within vehicle passenger room has been upgraded as well recently. One of the requirements for upgrading the decorativeness within vehicle passenger room is the requirement of making the outlet opening of air-conditioning register less noticeable, that is, the requirement of keeping the top surface of the outlet opening of instrument panel as low as possible. Specifically, it has been required to satisfy the requirement, making the outlet opening of air-conditioning register less noticeable, by reducing the outlet-opening area of air-conditioning register.

However, when the outlet-opening area of air-conditioning register is reduced, the quantities of the vertical blades and horizontal blades as well as their movable magnitudes have come to be restricted. As a result, it has become difficult to blow out air-conditioning air in desired directions.

Moreover, the conventional air-conditioning registers disclosed in Japanese Unexamined Utility Model Publication (KOKAI) No. 63-185,047 and Japanese Unexamined Utility Model Publication (KOKAI) No. 2-24,232 comprise the retainer whose side walls are curved and bendable blades, respectively, in order to improve the directivity in which air-conditioning air blows out. However, the conventional air-conditional registers have exhibited inadequate directivity when the outlet-opening area is reduced.

### SUMMARY OF THE INVENTION

The present invention has been developed in view of the aforementioned circumstances. It is therefore an object of the present invention to provide a register for air conditioning, which is good in terms of the directivity in which air-conditioning air blows out.

The inventors of the present invention have been investigating into air-conditioning registers over and over again. As result, they have completed the present invention.

A register for air conditioning according to the present invention comprises:

a register panel disposed in a vehicle passenger room, and having an outlet opening for air-conditioning air; and

a cylinder-shaped retainer demarcating a ventilation passage communicated with the outlet opening of the register panel, and having an inner opposite end and a register-panel-side opposite end;

the register-panel-side opposite end comprising at least one member selected from the group consisting of:

a top-surface wall demarcating a top surface of the ventilation passage, and disposed movably so as to make the top surface movable between diminishing the ventilation passage and enlarging the ventilation passage adjacent to the outlet opening of the register panel;

a bottom-surface wall demarcating a bottom surface of the ventilation passage, and disposed movably so as to make the bottom surface movable between diminishing the ventilation passage and enlarging the ventilation passage adjacent to the outlet opening of the register panel; and

paired side-surface walls demarcating paired side surfaces of the ventilation passage, and disposed movably so as to make the paired side surfaces movable between diminishing the ventilation passage and enlarging the ventilation passage adjacent to the outlet opening of the register panel.

The present air-conditioning register comprises one of the top-surface wall, the bottom-surface wall and the paired side-surface walls which demarcates the ventilation passage adjacent to the outlet opening of the cylinder-shaped retainer and which is disposed movably between diminishing the ventilation passage and enlarging the ventilation passage. Since one of the top-surface wall, the bottom-surface wall and the paired side-surface walls, which demarcates the ventilation passage adjacent to the outlet-opening of the retainer, thus moves, air-conditioning air moves along one of the movable walls and eventually blows out through the outlet opening of the register panel. As a result, the present air-conditioning register demonstrates upgraded directivity in blowing out air-conditioning air through the outlet opening. Moreover, even when the cross-sectional area of the retainer, or the outlet-opening area of the retainer is reduced, the present air-conditioning register can produce good directivity in which air-conditioning air blows out.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure.

FIG. 1 is a vertical cross-sectional diagram for illustrating an air-conditioning register according to Example No. 1 of the present invention.

FIG. 2 is another vertical cross-sectional diagram for illustrating the air-conditioning register according to Example No. 1 of the present invention.

FIG. 3 is still another vertical cross-sectional diagram for illustrating the air-conditioning register according to Example No. 1 of the present invention.

FIG. 4 is a horizontal cross-sectional diagram for illustrating the air-conditioning register according to Example No. 1 of the present invention.

FIG. 5 is a horizontal cross-sectional diagram for illustrating an air-conditioning register according to Example No. 2 of the present invention.

FIG. 6 is a vertical cross-sectional diagram for illustrating the air-conditioning register according to Example No. 2 of the present invention.

FIG. 7 is a horizontal cross-sectional diagram for illustrating an air-conditioning register according to Example No. 3 of the present invention.

FIG. 8 is a cross-sectional diagram for illustrating the arrangement of a unit for operating the vertical blades of the air-conditioning register according to Example No. 3 of the present invention.

FIG. 9 is a cross-sectional diagram for illustrating the arrangement of a unit for operating the damper of the air-conditioning register according to Example No. 3 of the present invention.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims. Hereinafter, the present invention will be described with reference to forms of embodying the present air-conditioning register applied to vehicles.

An air-conditioning register according to the present invention comprises a register panel, and a retainer.

The register panel is exposed within a vehicle passenger room, and has an outlet opening for air-conditioning air. That is, the register panel forms an outlet opening through which air-conditioning air blows out into a vehicle passenger room.

The retainer is a cylinder-shaped component member for demarcating a ventilation passage communicating with the outlet opening of the register panel. Accordingly, the retainer demarcates the ventilation passage in which the air-conditioning air flows. Moreover, the retainer is a component member for flowing the air-conditioning air, which an air conditioner prepares, to the outlet opening. The retainer has an inner opposite end, and a register-panel-side opposite end. The register-panel-side opposite end can preferably be formed as a shape, which agrees with the outlet opening substantially. Consequently, the air-conditioning air, which has flowed in the retainer, flows out through the outlet opening without leaking to the outside.

Moreover, in the present air-conditioning register, the register-panel-side opposite end of the cylinder-shaped retainer comprises at least one member selected from the group consisting of: a top-surface wall demarcating a top surface of the ventilation passage, and disposed movably so as to make the top surface movable between diminishing the ventilation passage and enlarging the ventilation passage adjacent to the outlet opening of the register panel; a bottom-surface wall demarcating a bottom surface of the ventilation passage, and disposed movably so as to make the bottom surface movable between diminishing the ventilation passage and enlarging the ventilation passage adjacent to the outlet opening of the register panel; and paired side-surface walls demarcating paired side surfaces of the ventilation passage, and disposed movably so as to make the paired side surfaces movable between diminishing the ventilation passage and enlarging the ventilation passage adjacent to the outlet opening of the register panel. Note that the clause, “the surface of one of the walls moves to diminish the ventilation passage,” specifies such a state that the surface of one of the walls moves in the direction in which the leading end approaches the center of the ventilation passage. On the other hand, the clause, “the surface of one of the walls moves to enlarge the ventilation passage,” specifies such a state that the surface of one of the walls moves in the direction in which the leading end goes away from the center of the ventilation passage. Thus, in the present air-conditioning register, one of the top-surface wall, bottom-surface wall and paired side-surface walls, which demarcates the ventilation passage adjacent to the outlet opening of the retainer, is formed movably. That is, since one of the top-surface wall, bottom-surface wall and paired side-surface walls, which demarcates the ventilation passage adjacent to the outlet opening, can move, the one of the top-surface wall, bottom-surface wall and paired side-surface walls can deflect the flowing direction of air-conditioning air. As a result, the present air-conditioning register exhibits upgraded directivity in which air-conditioning air blows out.

As described above, the register-panel-side opposite end can preferably be formed as a shape which agrees with the outlet opening of the register panel substantially. Thus, the air-conditioning air, which has flowed in the retainer, flows out through the outlet opening without leaking to the outside. Moreover, at least one of the top-surface wall, bottom-surface wall and paired side-surface walls, which makes the register-panel-side opposite end of the retainer, moves between diminishing the ventilation passage and enlarging the ventilation passage. When at least one of the top-surface wall, bottom-surface wall and paired side-surface walls moves while the register-panel-side opposite end of the retainer keeps agreeing with the outlet opening substantially, the base end of at least one of the top-surface wall, bottom-surface wall and paired side-surface walls, that is, the opposite end with respect to the register-panel-side opposite end of the retainer (i.e., the inner opposite end of the retainer) is displaced with respect to the register-panel-side opposite end in the top/bottom direction or in the right/left direction. Note that, even when at least one of the top-surface wall, bottom-surface wall and paired side-surface walls thus moves, the retainer maintains the cylinder shape, in which the air-conditioning air flows. In other words, at least one of the top-surface wall, the bottom-surface wall and the paired side-surface walls can preferably be formed as a plate shape, and can preferably be supported swingably about the register-panel-side opposite end.

For example, the retainer can preferably be arranged to comprise: a plate-shaped wall, which makes at least one of the top-surface wall, the bottom-surface wall and the paired side-surface walls; a cylinder-shaped retainer body; and a connector, which demarcates a part of the ventilation passage in the retainer and at the same time which connects the retainer body with at least one of the top-surface wall, the bottom-surface wall and the paired side-surface walls. Note that, in the thus arranged retainer, the retainer body forms the top-surface wall, the bottom-surface wall and the paired side-surface walls which make the register-panel-side opposite end of the retainer but which do not move in the direction diminishing and enlarging the ventilation passage, for instance, the paired side-surface walls when the retainer arranged as described above has the top-surface wall and the bottom-surface wall, which can move between diminishing the ventilation passage and enlarging the ventilation passage, only. Even if such is the case, it is not excluded to further arrange the paired side-surface walls so as to move in such directions as the paired side-surface walls do not diminish and enlarge the ventilation passage. To put it differently, when the top-surface wall and the bottom-surface wall move between diminishing the ventilation passage and enlarging the ventilation passage, it is not ruled out to make the walls of the retainer body, which are disposed correspondingly to the paired side-surface walls, movable in the direction along the exposed or front surface of the register panel, for instance, in the top/bottom direction.

The present air-conditioning register can comprise at least one of the top-surface wall, the bottom-surface wall and the paired side-surface walls, which can move between diminishing the ventilation passage and enlarging the ventilation passage. However, at least two of the top-surface wall, the bottom-surface wall and the paired side-surface walls can preferably be selected to make paired walls which face to each other and which can move between diminishing the ventilation passage and enlarging the ventilation passage. If such is the case, the paired walls can preferably be arranged so that one of the paired walls move so as to diminish the ventilation passage when the other one of the paired walls move to enlarge the ventilation passage. The moving magnitudes of the paired walls, which face to each other, or the angles which the respective walls make with respect to a predetermined plane, are not limited in particular. However, the respective moving magnitudes of the paired walls can preferably be equal to each other. Moreover, the paired wall can be connected with each other by a link mechanism so that they move in an interlocking manner.

In vehicles, it has been required from the viewpoint of decorativeness to diminish the dimension of the outlet opening of the register panel, through which air-conditioning air flows out, in the top/bottom direction. The requirement demands to upgrade the top/down directivity in regard to the direction of air-conditioning air, which blows out through the outlet opening. Accordingly, the retainer can preferably deflect the flowing direction of the air-conditioning air adjacent to the outlet opening in the top/down direction. In other words, the present air-conditioning register can preferably comprise the retainer, which is provided with the top-surface wall and bottom-surface wall disposed movably between diminishing the ventilation passage and enlarging the ventilation passage.

As described above, paired walls, which face to each other, can preferably move in an interlocking manner. Moreover, the top-surface wall and bottom-surface wall can especially preferably move in an interlocking manner. Specifically, the bottom-surface wall can preferably move so as to enlarge the ventilation passage when the top-surface wall moves to diminish the ventilation passage; and the bottom-surface wall can preferably move so as to diminish the ventilation passage when the top-surface wall moves to enlarge the ventilation passage.

The present air-conditioning register can preferably comprise at least one member selected from the group consisting of: a vertical blade supported and accommodated swingably in the retainer, and making a flowing direction of the air-conditioning air adjustable laterally; and a horizontal blade supported and accommodated swingably in the retainer, and making a flowing direction of the air-conditioning air adjustable longitudinally. When being provided with the vertical blade and/or the horizontal blade, the vertical blade and/or the horizontal blade upgrades the directivity in regard to the direction of air-conditioning air which blows out through the outlet opening of the register panel.

The vertical blade or the horizontal blade is supported and accommodated swingably in the retainer, and makes a flowing direction of the air-conditioning air adjustable laterally or longitudinally. The vertical blade extends longitudinally within the retainer. The horizontal blade extends laterally within the retainer. The vertical blade controls the flow direction of the air-conditioning air, which flows out through the outlet opening of the register panel, laterally. The horizontal blade controls the flow direction of the air-conditioning air, which flows out through the outlet opening of the register panel, longitudinally. In the present specification, the lateral direction and longitudinal direction designate directions perpendicular to each other. Specifically, the lateral direction can preferably specify the width-wise or right/left direction of vehicle, and the longitudinal direction can preferably specify the height-wise or top/bottom direction of vehicle.

In the present air-conditioning register, it is not limited in particular on how to support and accommodate the vertical blade and/or the horizontal blade swingably in the retainer. For example, when the retainer is provide with a top-surface wall and a bottom-surface wall only at the base end, that is, at the inner opposite end, it is possible to exemplify such a mode that the horizontal blade is held onto paired side-surface walls, which demarcate paired side surfaces, adjacent to the register-panel-side opposite end of the retainer; and the vertical blade is held onto the horizontal blade. As an alternative mode, the vertical blade can be held onto the retainer or the register panel.

Moreover, it is not limited in particular on how to operate the vertical blade and/or the horizontal blade. For instance, it is possible to exemplify the following methods: operating the vertical blade and/or the horizontal blade manually directly, and operating the vertical blade and/or the horizontal blade with operating means for operating the vertical blade and/or the horizontal blade, means which is disposed in the present air-conditioning register therefor and can be operable from within a vehicle passenger room.

The present air-conditioning register is connected with an air conditioner, which prepares the air-conditioning air, at the base end of the retainer, that is, at the inner opposite end thereof.

Note that, except for the above-described specific arrangements, the present air-conditioning register can be arranged in the same manner as conventionally known air-conditioning registers. For example, the present air-conditioning register can further comprise a damper for shutting off the air-conditioning air from blowing out.

### EXAMPLES

Hereinafter, the present air-conditioning register will be described with reference to specific examples.

As the specific examples of the present air-conditioning register, the following air-conditioning registers for vehicle were manufactured.

### Example No. 1

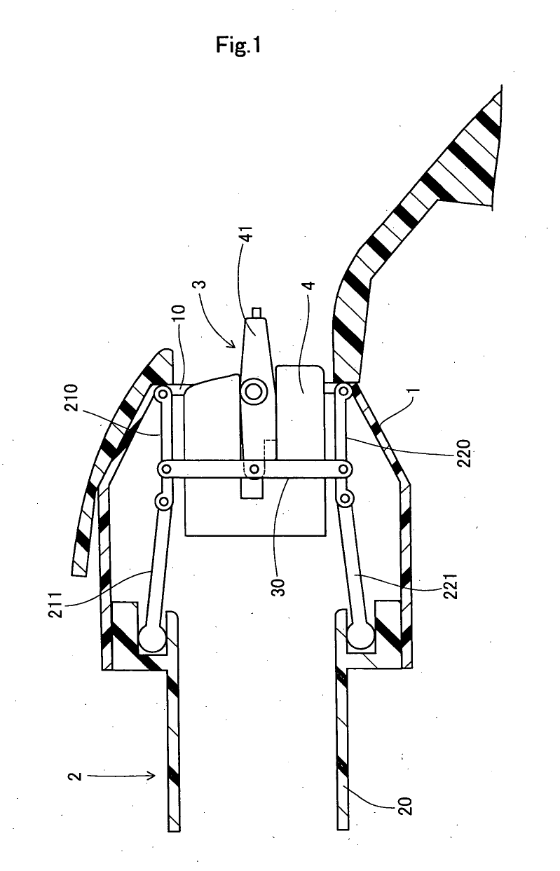

FIGS. 1 through 4 illustrate an air-conditioning register according to Example No. 1 of the present invention.

The air-conditioning register according to Example No. 1 comprises a register panel 1, a retainer 2, a horizontal blade 3, and a vertical blade assembly 4.

The register panel 1 has an outlet opening 10, which opens to and within a vehicle passenger room. Moreover, the register panel 1 holds one of the opposite ends of the retainer 2, the opposite end of the retainer 2 which is placed on the side of the outlet opening 10.

The retainer 2 communicates an air conditioner (not shown), which prepares air-conditioning air, with the outlet opening 10 of the register panel 1. The retainer 2 is formed as a cylinder shape, which demarcates a ventilation passage therein. The air-conditioning air, which the air conditioner has prepared, flows in the ventilation passage. In the air-conditioning register according to Example No. 1, the retainer 2 demarcates a ventilation passage, which is formed as a rectangular shape in cross section, adjacent to the outlet opening 10. Moreover, the retainer 2 is connected to the register panel 1 at one of the opposite ends, which is placed on the side of the register panel 1.

In addition, as shown in FIGS. 1 through 3, the retainer 2 comprises a retainer body 20, a top-surface wall 210, a top connector 211, a bottom-surface wall 220, and a bottom connector 221. The retainer body 20 is connected to the air conditioner. The top-surface wall 210 is formed as a substantially-rectangle-shaped plate, and demarcates the top-wall surface of the ventilation passage adjacent to the leading end of the retainer 2, which is connected to the register panel 1. The top connector 211 connects the top-surface wall 210 with the retainer body 20. The bottom-surface wall 220 is formed as a substantially-rectangle-shaped plate, is disposed so as to face the top-surface wall 210, and demarcates the bottom-wall surface of the ventilation passage adjacent to the leading end of the retainer 2, which is connected to the register panel 1. The bottom connector 221 connects the bottom-surface wall 220 with the retainer body 20. Note that the ventilation passage, which the retainer 2 demarcates and in which the air-conditioning air flows, has a substantially-rectangle-shaped cross section adjacent to the outlet opening 10 of the retainer 1.

The top-surface wall 210 and bottom-surface wall 220 are connected to the register panel at the leading end, respectively. Moreover, the top-surface wall 210 and bottom-surface wall 220 are connected swingably to the register panel 1 about the leading end, respectively. That is, the top-surface wall 210 and bottom-surface wall 220 are disposed movably between diminishing the ventilation passage and enlarging the ventilation passage on the leading-end side, respectively. Specifically, the top-surface wall 210 is disposed movably so that the angle made between the bottom surface of the top-surface wall 210 and the axis, which connects the center of the outlet opening 10 and the center of the ventilation passage at the leading end of the retainer body 20, is variable; and the bottom-surface wall 220 is disposed movably so that the angle made between the top surface of the bottom-surface wall 220 and the axis is variable.

The base or inner ends of the top-surface wall 210 and bottom-surface wall 220 are connected to the leading ends of the top connector 211 and bottom connector 221. Note that the top-surface wall 210 and top connector 211 are connected swingably to each other at the connection; and the bottom-surface wall 220 and bottom connector 221 are connected swingably to each other at the connection.

The top connector 211 and bottom connector 221 are connected to the retainer body 20. The outer peripheral surface of the retainer body 20 is provided with a groove, which opens toward the leading end of the retainer body 20. The base ends of the top connector 211 and bottom connector 221 are fitted into the groove reciprocally in the depth-wise direction of the groove. The groove is formed so that the top connector 211 and bottom connector 221 whose base ends are fitted into the groove can swing about the base ends. Specifically, as shown in FIGS. 1 through 3, the groove has paired side walls, which are disposed in the top/down direction in the drawing; and one of the paired side walls (that is, the upper side wall of the groove into which the bottom connector 221 is fitted) is formed shorter than the other one of the paired side walls (that is, the lower side wall of the groove into which the bottom connector 221 is fitted), for instance.

Moreover, in the air-conditioning register according to Example No. 1, the retainer body 20 forms paired side-surface walls which demarcate a part of the ventilation passage adjacent to the leading end of the retainer 2, that is, adjacent to the leading end of the retainer 2 along which the subassembly of the top-surface wall 210 and top connector 211 and the subassembly of the bottom-surface wall 220 and bottom connector 221 extend outward. In other words, the paired side-surface walls, which form a part of the ventilation passage at the leading end of the retainer 2, do not move.

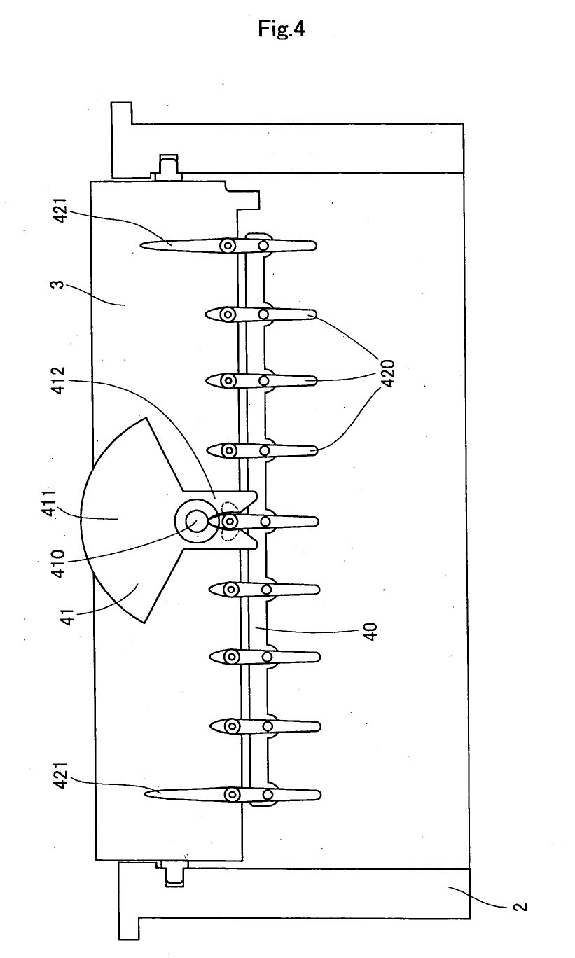

The horizontal blade 3 is formed as a strip shape, and is supported and accommodated swingably in the ventilation passage within the retainer 2. As shown in FIG. 4, the horizontal blade 3 is assembled with the paired side walls of the retainer 2 in such a manner that it is disposed swingably about the width-wise center of the strip shape as the swing center; and it is held by the paired side walls at the opposite ends in the length-wise direction of the strip shape. Specifically, as shown in FIG. 1, the horizontal blade 3 is held by the paired side walls so that the swing center, the width-wise center of the strip shape, is placed at the same position as the leading ends of the top-surface wall 210 and bottom-surface wall 220 are located. To put it differently, the width-wise center of the strip-shaped horizontal blade 3 and the leading ends of the top-surface wall 210 and bottom-surface wall 220 are placed at the same position in the flowing direction of air-conditioning air. Moreover, as shown in FIG. 1 through 3, the leading width-wise opposite end of the strip-shaped horizontal blade 3, one of the width-wise opposite ends of thereof, project beyond the outlet opening 10 of the register panel 1.

As shown in FIG. 4, the vertical blade assembly 4 comprises a plurality of strip-shaped vertical blade members 421, 420; and is supported and accommodated swingably in the ventilation passage within the retainer 2. The vertical blade assembly 4 is held to the horizontal blade 3. Specifically, as shown in the drawing, two of the vertical blade members of the vertical blade assembly 4, the major vertical blade members 421 are assembled with one of the width-wise opposite ends of the horizontal blade 3, that is, with the base or inner width-wise opposite end thereof, in such a manner that they are disposed swingably about the width-wise center of the strip shape as the swing center. Moreover, the other vertical blade members of the vertical blade assembly 4, the minor vertical blade members 420, are assembled with the base or inner width-wise opposite end of the horizontal blade 3 in such a manner that they are disposed swingably about the leading width-wise opposite end of the strip shape substantially, which is placed outward away from the absolute width-wise center, as the swing center. In addition, the major and minor vertical blade members 421, 420 are disposed so that their width-wise directions can coincide with the flowing direction of air-conditioning air.

Moreover, in the vertical blade assembly 4, the major and minor vertical blade members 421, 420 are assembled with the horizontal blade 3 so that they can keep being parallel to each other. Specifically, as shown in FIG. 4, the respective vertical blade members 421, 420 are connected to each other at their base-opposite-end sides (or inner-opposite-end sides), which are placed more adjacent to their base or inner opposite ends than their swing centers are placed, with a substantially rod-shaped connector 40.

Note that, in the air-conditioning register according to Example No. 1, the two of the vertical blade members of the vertical blade assembly 4, the major vertical blade members 421, 421, which are disposed to face the paired side walls of the retainer 2, are formed as a strip shape whose leading width-wise opposite end, one of the width-wise opposite ends of the strip shape, protrudes beyond the leading width-wise opposite ends of the other strip-shaped vertical blade members of the vertical blade assembly 4, the minor vertical blade members 420. That is, the major vertical blade members 421, 421, which are disposed at the length-wise opposite ends of the vertical blade assembly 4, are formed as a strip shape whose width is made wider than the width of the strip-shaped minor vertical blade members 420 so that the leading width-wise opposite ends of the major vertical blade members 421, 421 protrude beyond the leading width-wise opposite ends of the minor vertical blade members 420, which are disposed on inner sides with respect to the major vertical blade members 421, 421.

Moreover, the air-conditioning register according to Example No. 1 further comprises a vertical-blade-assembly operation knob 41 for controlling the swing direction of the major and minor vertical blade members 421, 420 of the vertical blade assembly 4. The vertical-blade-assembly operation knob 41 is held swingably to the horizontal blade 3. The vertical-blade-assembly operation knob 41 comprises a swing center 410, a leading end 411, and a base end 412. The leading end 411 is formed as a substantially sector shape which protrudes from the swing center 410. The base end 412 is formed as a plate shape which holds one of the minor vertical blade members 420 between its legs in the thickness-wise direction of the minor vertical blade member 420. Thus, when an operator moves the leading end 411 of the vertical-blade-assembly operation knob 41 in the peripheral direction about the swing center 410, he or she can adjust the swing direction of the major and minor vertical blade members 421, 420 of the vertical blade assembly 4.

In addition, as shown in FIGS. 1 through. 3, the air-conditioning register according to Example No. 1 further comprises a link 30 which connects the top-surface wall 210, the bottom-surface wall 220 and the horizontal blade 3 to each other so that they can keep being parallel to each other. Specifically, as shown in the drawings, the link 30 connects the top-surface wall 210, the bottom-surface wall 220 and the horizontal blade 3 integrally at one of the width-wise opposite ends of the horizontal blade 3, that is, at the base or inner width-wise opposite end thereof.

In the air-conditioning register according to Example No. 1, an operator swings the horizontal blade 3 and the vertical blade members 421, 420 of the vertical blade assembly 4 in desirable directions to blow out the air-conditioning air through the outlet opening 10 of the register panel 1 in desirable directions.

In the air-conditioning register according to Example No. 1, an operator swings the vertical blade members 421, 420 of the vertical blade assembly 4 to adjust the flowing direction of the air-conditioning air laterally. When adjusting the flowing direction of the air-conditioning air laterally, an operator manipulates the vertical-blade-assembly operation knob 41 to swing the vertical blade members 421, 420 of the vertical blade assembly 4. Accordingly, the air-conditioning register according to Example No. 1 blows out the air-conditioning air in the width-wise direction of the vertical-blade members 421, 420, that is, in the direction in which the strip-shaped vertical-blade members 421, 420 extends laterally. Note that the air-conditioning register according to Example No. 1 comprises the paired major vertical blade members 421, 421, which are disposed at the opposite side ends of the vertical blade assembly 4. Moreover, the paired major vertical blade members 421, 421 have the leading ends, which protrude beyond the leading end of the minor vertical blade members 420. To put it differently, the paired major vertical blade members 421, 421 have a longer length in the flowing direction of the air-conditioning air than that of the minor vertical blade members 420. Consequently, the paired major vertical blade members 421, 421 can not only change the flowing direction of the air-conditioning air laterally, but also upgrade the lateral directivity of the air-conditioning air flowing adjacent to the paired side-surface walls of the retainer 2.

In the air-conditioning register according to Example No. 1, an operator swings the horizontal blade 3 to adjust the flowing direction of the air-conditioning air longitudinally. When adjusting the flowing direction of the air-conditioning air longitudinally, an operator manipulates one of the width-wise opposite ends of the horizontal blade 3, which protrude from the outlet opening 10 of the register panel 1, to swing the horizontal blade 3. Note that the air-conditioning register according to Example No. 1 comprises the horizontal blade 3, which is connected with the top-surface wall 210 and bottom-surface wall 220 of the retainer 2, by the link 30. Accordingly, when the horizontal blade 3 moves, the link 30 transmits the movement of the horizontal blade 3 to the top-surface wall 210 and bottom-surface wall 220. Consequently, the top-surface wall 210 and bottom-surface wall 220 move in the same manner as the horizontal blade 3.

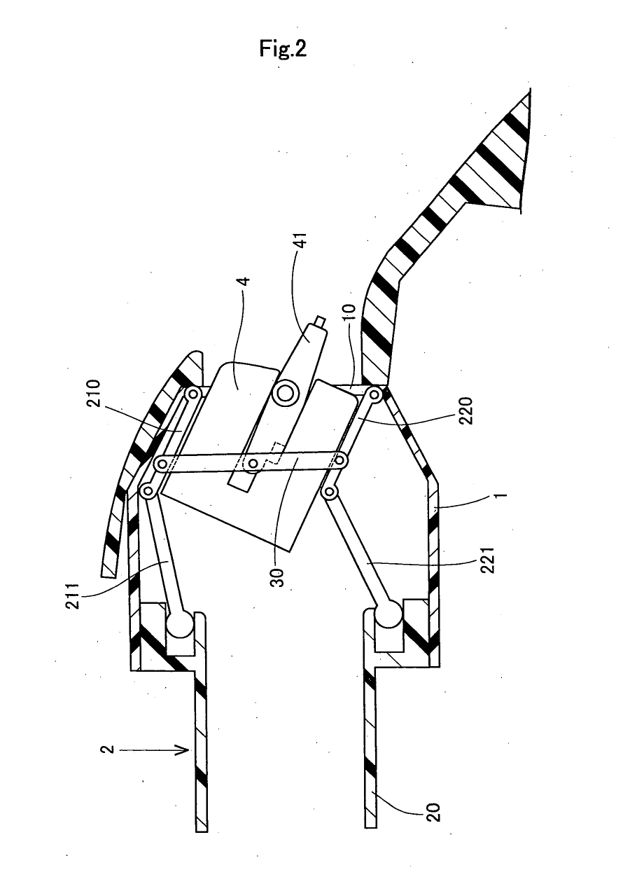

When an operator adjusts the horizontal blade 3 in order to blow out the air-conditioning air through the outlet opening 10 of the register panel 1 downward, that is, when an operator adjusts the horizontal blade 3 from the state shown in FIG. 1 to the state shown in FIG. 2, how the air-conditioning register according to Example No. 1 operates will be hereinafter described.

First of all, an operator manipulates a part of the horizontal blade 3, which protrudes from the outlet opening 10 of the register panel 1, to push the horizontal blade 3 downward. When the operator thus manipulates the horizontal blade 3, the base or inner width-wise opposite ends of the horizontal blade 3, one of the width-wise opposite ends thereof, is pushed up. The pushed-up base or inner width-wise opposite end of the horizontal blade 3 pushes up the link 30 as well. The pushed-up link 30 likewise pushes up the parts of the top-surface wall 210 and bottom-surface wall 220, which are connected, to the link 30. The top-surface wall 210 and bottom-surface wall 220 are connected to the register panel 1 swingably about the leading or outer ends. Accordingly, when the base or inner width-wise opposite end of the horizontal blade 3 is pushed up, the top-surface wall 210 and bottom-surface wall 220 are moved to swing about the leading or outer ends. In this instance, since the base or inner opposite end of the top-surface wall 210, one of the opposite ends thereof, is pushed up, the base or inner opposite end of the top-surface wall 210 is separated from the axis, which connects between the leading-end center of the retainer body 20 and the center of the outlet opening 10, as shown in FIG. 2. That is, the top-surface wall 210, which demarcates the top surface of the ventilation passage within the retainer 2, is swung upward to partially enlarge the ventilation passage adjacent to the base or inner opposite end of the top-surface wall 210. Moreover, since the base or inner opposite end of the bottom-surface wall 220, one of the opposite ends thereof, is pushed up, the base or inner opposite end of the bottom-surface wall 220 comes close to the axis, which connects between the leading-end center of the retainer body 20 and the center of the outlet opening 10, as shown in FIG. 2. That is, the bottom-surface wall 220, which demarcates the bottom surface of the ventilation passage within the retainer 2, is swung upward to partially diminish the ventilation passage adjacent to the base or inner opposite end of the bottom-surface wall 220.

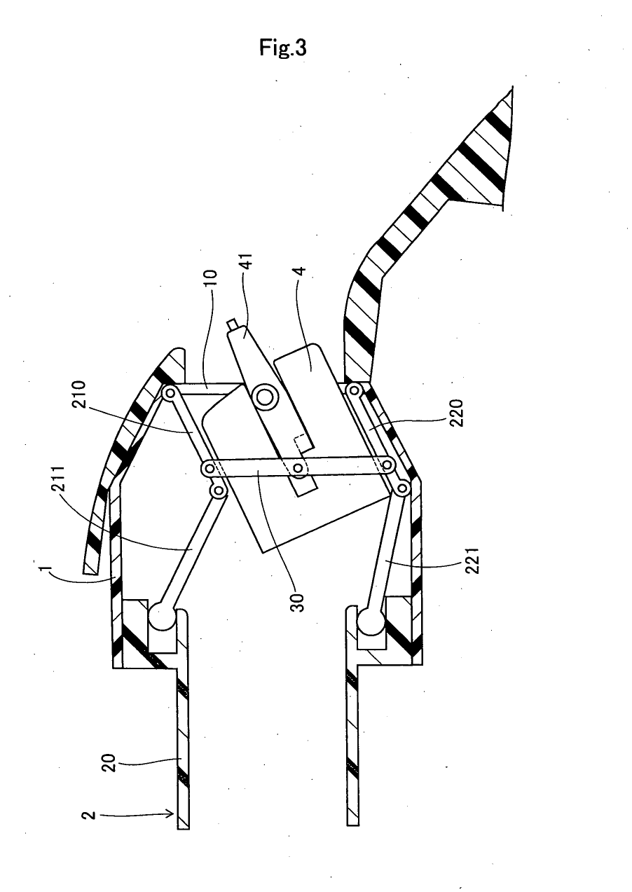

The top-surface wall 210 and bottom-surface wall 220 are connected to the retainer body 20 by way of the top connector 211 and bottom connector 221. The top connector 211 and bottom connector 221 enable both of the top-surface wall 210 and bottom-surface wall 220 to form the ventilation passage even when both of the top-surface wall 210 and bottom-surface wall 220 move. When the base or inner opposite ends of both the top-surface wall 210 and bottom-surface wall 220 are pushed up, the leading or outer opposite ends of both the top connector 211 and bottom connector 221 are pushed up as shown in FIG. 2. In this instance, the base or inner ends of both the top connector 211 and bottom connector 221 are inhibited from moving upward or downward by the outer peripheral wall of the groove formed around the retainer body 20, because they are kept being fitted into the groove. Thus, both of the top connector 211 and bottom connector 221 swing about the base or inner opposite ends. Here, note that, when both of the top-surface wall 210 and bottom-surface wall 220 move to swing, the base or inner opposite end of the top-surface wall 210 moves slightly toward the register panel 1 accompanied by the swinging top-surface wall 210; and the base or inner opposite end of the bottom-surface wall 220 moves slightly away from the register panel 1 accompanied by the swinging bottom-surface wall 220, or vise versa, as shown in FIG. 2 or 3. When the base or inner opposite ends of both the top-surface wall 210 and bottom-surface wall 220 thus move toward the register panel 1, both of the top connector 211 and bottom connector 212 are driven by the moving top-surface wall 210 and bottom-surface wall 220. Even when both of the top connector 211 and bottom connector 212 thus move, the base or inner opposite ends of both of the top connector 211 and bottom connector 212 move simply toward the outlet opening 10 of the register panel 1 but do not come off from the groove formed around the retainer body 20. As a result, the top connector 211 and bottom connector 221 enable both of the top-surface wall 210 and bottom-surface wall 220 to form the ventilation passage adjacent to the outlet opening 10 of the register panel 1.

A series of the above-described operations bend the ventilation passage downward or upward adjacent to the outlet opening 10 of the register panel 1 within the retainer 2. Moreover, in the air-conditioning register according to Example No. 1, when an operator manipulates the horizontal blade 3 to blow out the air-conditioning air upward through the outlet opening 10, that is, he or she adjusts the horizontal blade 3 from the state shown in FIG. 1 to the state shown in FIG. 3, the top-surface wall 210 and bottom-surface wall 220 move in the direction opposite to the above-described direction. Specifically, when the base or inner opposite end of the top-surface wall 210 is pushed down, the ventilation passage is diminished partially adjacent to the outlet opening 10 within the retainer 2. On the other hand, when the base or inner opposite end of the bottom-surface wall 220 is pushed down, the ventilation passage is enlarged partially adjacent to the outlet opening 10 within the retainer 2.

The air-conditioning register according to Example No. 1 enables an operator to bend the ventilation passage, in which the air-conditioning air flows, in the up/down direction adjacent to the outlet opening 10 of the register panel 1 within the retainer 2. This fact implies that the air-conditioning register according to Example No. 1 can blow out the air-conditioning air through the outlet opening 10 in desired directions even when the cross-sectional area of the ventilation passage is reduced. Moreover, it also implies that the air-conditioning register according to Example No. 1 can blow out the air-conditioning air through the outlet opening 10 in desired directions even when the top/down-wise width of the outlet opening 10 is reduced. In other words, the air-conditioning register according to Example No. 1 demonstrates good directivity in regard to the direction of air-conditioning air which blows out through the outlet opening 10.

### Example No. 2

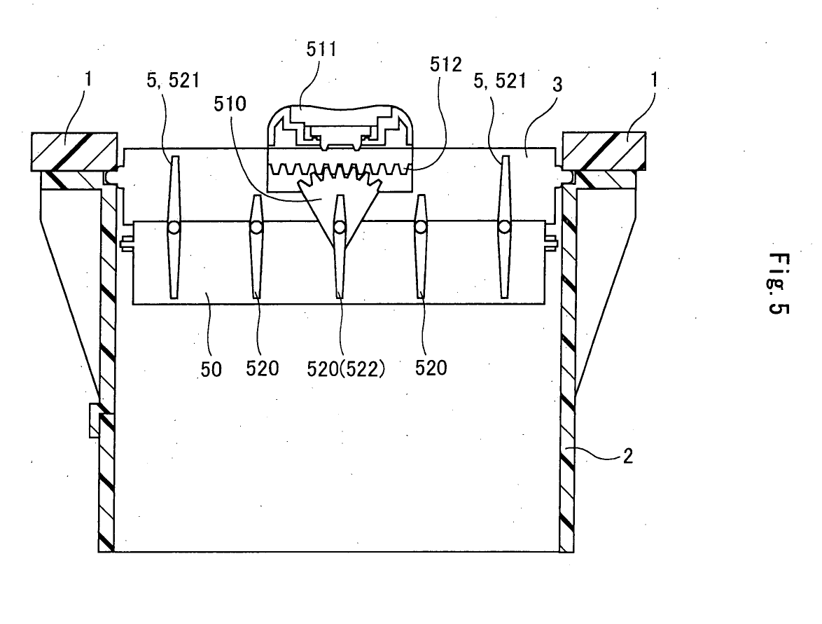

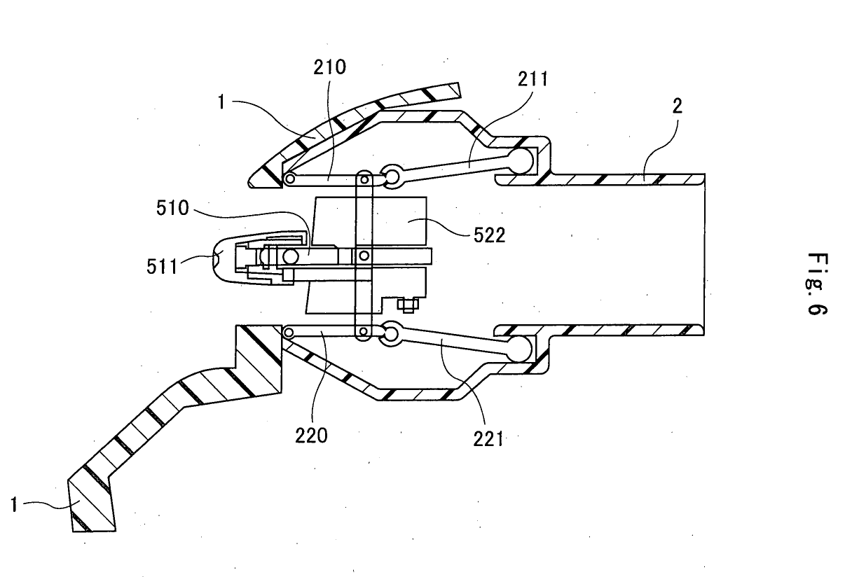

Except that the vertical-blade-assembly operation unit is arranged differently, an air-conditioning register according to Example No. 2 of the present invention comprises the same arrangements as those of the air-conditioning register according to Example No. 1. FIGS. 5 and 6 illustrate the specific structures of the air-conditioning register according to Example No. 2.

The air-conditioning register according to Example No. 2 comprises a register panel 1, a retainer 2, a horizontal blade 3, and a vertical blade assembly 5.

In the air-conditioning register according to Example No. 2, the register panel 1, the retainer 2 and the horizontal blade 3 are arranged in the same manner as those in the air-conditioning register according to Example No. 1. Hence, they will not be described herein in particular.

As shown in FIG. 5, the vertical blade assembly 5 comprises a plurality of strip-shaped vertical blade members 521, 520; and is supported and accommodated swingably in the ventilation passage within the retainer 2. The vertical blade assembly 5 is held to the horizontal blade 3. Specifically, as shown in the drawing, two of the vertical blade members of the vertical blade assembly 5, the major vertical blade members 521 are assembled with one of the width-wise opposite ends of the horizontal blade 3, that is, with the base or inner width-wise opposite end thereof, in such a manner that they are disposed swingably about the width-wise center of the strip shape as the swing center. Moreover, the other vertical blade members of the vertical blade assembly 5, the minor vertical blade members 520, are assembled with the base or inner width-wise opposite end of the horizontal blade 3 in such a manner that they are disposed swingably about the leading width-wise opposite end of the strip shape substantially, which is placed outward away from the absolute width-wise center of the strip shape, as the swing center. In addition, the major and minor vertical blade members 521, 520 are disposed so that their width-wise directions can coincide with the flowing direction of air-conditioning air.

Moreover, in the vertical blade assembly 5, the major and minor vertical blade members 521, 520 are assembled with the horizontal blade 3 so that they can keep being parallel to each other. Specifically, as shown in FIG. 5, the respective vertical blade members 521, 520 are connected to each other at their base-opposite-end sides (or inner-opposite-end sides), which are placed more adjacent to their base or inner opposite ends than their swing centers are placed, with a substantially plate-shaped connector 50.

Note that, in the air-conditioning register according to Example No. 2, the two of the vertical blade members of the vertical blade assembly 5, the major vertical blade members 521, 521, which are disposed to face the paired side walls of the retainer 2, are formed as a strip shape whose leading width-wise opposite end, one of the width-wise opposite ends of the strip shape, protrudes beyond the leading width-wise opposite ends of the other strip-shaped vertical blade members of the vertical blade assembly 5, the minor vertical blade members 520. That is, the major vertical blade members 521, 521, which are disposed at the length-wise opposite ends of the vertical blade assembly 5, are formed as a strip shape whose width is made wider than the width of the strip-shaped minor vertical blade members 520 so that the leading width-wise opposite ends of the major vertical blade members 521, 521 protrude beyond the leading width-wise opposite ends of the minor vertical blade members 520, which are disposed on inner sides with respect to the major vertical blade members 521, 521.

Moreover, the air-conditioning register according to Example No. 2 further comprises a vertical-blade-assembly operation unit for controlling the swing direction of the major and minor vertical blade members 521, 520 of the vertical blade assembly 5. As shown in FIG. 5, the vertical-blade-assembly operation unit comprises a gear 510, and an operation knob 511. The gear 510 is formed as a substantially sector shape, which extends toward a vehicle passenger room, and is disposed integrally with one of the three minor vertical blades 520, the central minor vertical blade 522, which is placed at the middle of the ventilation passage within the retainer 2. The operation knob 511 is disposed slidably on one of the width-wise opposite ends of the horizontal blade 3, the leading width-wise opposite end thereof. Moreover, the operation knob 511 has an engager 512, which meshes with the gear teeth formed partially around the substantially-sector-shaped outer peripheral surface of the gear 510. Thus, when an operator slides the operation knob 511 along the horizontal blade 3, the gear 510, which meshes with the engager 512 of the operation knob 511, swings to swing the major and minor vertical blade members 521, 520 of the vertical blade assembly 5, which are held to the horizontal blade 3 and are connected to each other by way of the connector 50. Consequently, the operator can adjust the swing direction of the major and minor vertical blade members 521, 520 of the vertical blade assembly 5.

The air-conditioning register according to Example No. 2 differs from the air-conditioning register according to Example No. 1 only in that the vertical-blade-assembly operation unit for operating the vertical blade assembly 5 is arranged differently from the vertical-blade-assembly operation knob 41 in Example No. 1. Accordingly, the air-conditioning register according to Example No. 2 demonstrates the same advantages in the same manner as the air-conditioning register according to Example No. 1.

Note that the air-conditioning register according to Example No. 2 comprises the gear 510 for operating the vertical blade assembly 5, which is disposed on the top surface of the horizontal blade 3. However, it does not matter at all that the gear 510 is disposed on the bottom surface of the horizontal blade 3. Moreover the air-conditioning register according to Example No. 2 comprises the operation knob 511, which is formed as a substantially letter “U” shape so that it holds the top and bottom surfaces of the horizontal blade 3. However, as far as the operation knob 511 has the engager 512, it can be formed any shape, for example, as a plate shape which is disposed parallelly to the horizontal blade 3.

### Example No. 3

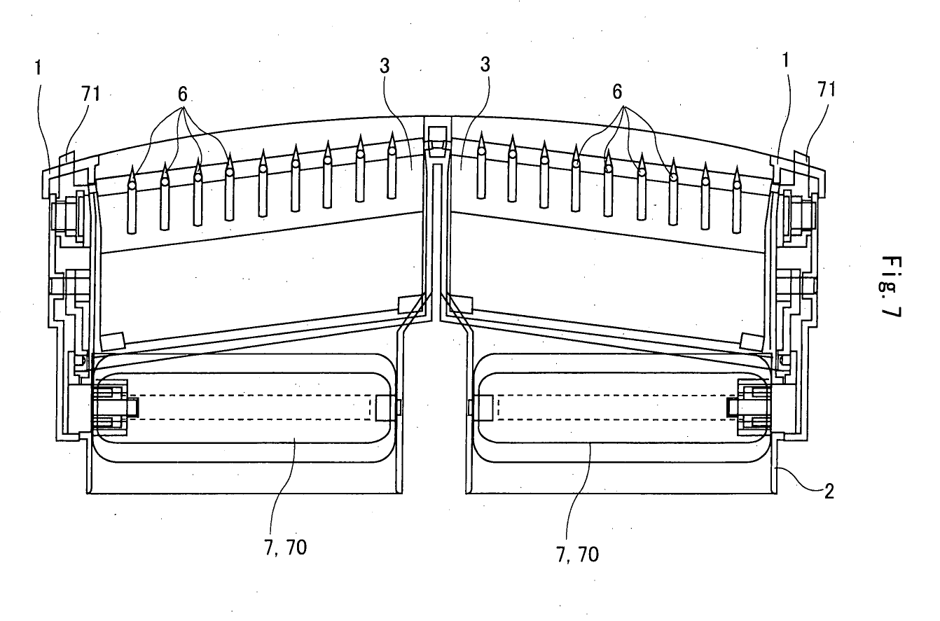

FIGS. 7 through 9 illustrate the specific structures of an air-conditioning register according to Example No. 3 of the present invention.

The air-conditioning register according to Example No. 3 comprises two outlet openings. Specifically, the air-conditioning register according to Example No. 3 comprises a register panel 1 having two outlet openings, two retainers 2, and two sets of a horizontal blade 3 and a vertical blade assembly 6. The register panel 1 demarcates the two outlet openings. The retainers 2 communicate with the outlet openings, respectively. Each set of the horizontal blade 3 and vertical blade assembly 6 is disposed in each of the outlet openings.

In the air-conditioning register according to Example No. 3, the register panel 1 and the retainers 2 are arranged in the same manner as those in the air-conditioning register according to Example No. 1. Hence, they will not be described herein in particular.

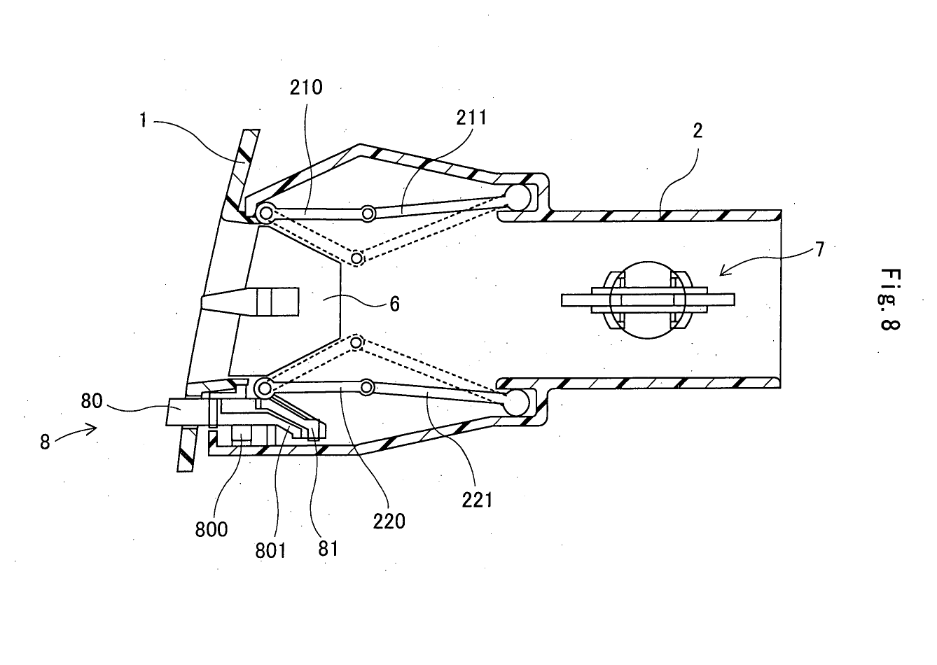

The horizontal blades 3 are formed as a strip shape, and are supported and accommodated swingably in the ventilation passages within the retainers 2, respectively. As shown in FIG. 7, each of the horizontal blades 3 is assembled with the paired side walls of the retainers 2 in such a manner that it is disposed swingably about the width-wise center of the strip shape as the swing center; and it is supported by the paired side walls at the opposite ends in the length-wise direction of the strip shape. Specifically, as shown in FIG. 8, each of the horizontal blades 3 is supported by the paired side walls so that the swing center, the width-wise center of the strip shape, is placed at the same position as the leading ends of the top-surface wall 210 and the bottom-surface wall 220 are located. To put it differently, the width-wise center of each of the strip-shaped horizontal blades 3 and the leading ends of the top-surface wall 210 and the bottom-surface wall 220 are placed at the same position in the flowing direction of air-conditioning air.

As shown in FIG. 7, each of the vertical blade assemblies 6 comprises a plurality of strip-shaped vertical blade members; and is supported and accommodated swingably in the ventilation passages within the retainers 2, respectively. As shown in the drawing, the vertical blade members of each of the vertical blade assemblies 6 are assembled with each of the horizontal blades 3. Specifically, as shown FIG. 8, the vertical blade members of each of the vertical blade assemblies 6 are held in the retainers 2 so that their leading ends are placed at the same position as the leading ends of the top-surface wall 210 and the bottom-surface wall 220 are located, respectively. That is, the leading end of each of the strip-shaped vertical blade members and the leading ends of the top-surface wall 210 and the bottom-surface wall 220 are placed at the same position in the flowing direction of air-conditioning air. Moreover, the vertical blade members of each of the vertical blade assemblies 6 are assembled swingably with the horizontal blades 3, respectively. Specifically, as shown in FIG. 7, the vertical blade members are assembled swingably with the horizontal blades 3, respectively, so that their width-wise direction of the strip shape parallels the flowing direction of air-conditioning air; and their swing centers are located more forward on their leading-end sides than their absolute width-wise centers are located. In addition, the vertical blade members of each of the vertical blade assemblies 6 are assembled with the horizontal blades 3, respectively, so that they can keep being parallel to each other.

Moreover, in the air-conditioning register according to Example No. 3, the vertical blade members of each of the vertical blade assemblies 6 are cut off at the width-wise top and bottom of the strip shape, which are placed closely to the top-surface wall 210 and bottom-surface wall 220 of the retainers 2, as shown in FIG. 8. Specifically, as shown in the drawing, the vertical blade members are cut off obliquely on the base or inner top side as well as on the base or inner bottom side, which are placed more rearward than their swing centers are placed. Thus, even when an operator manipulates the top-surface wall 210 and bottom-surface wall 220, the top-surface wall 210 and bottom-surface wall 220 are inhibited from interfering with the vertical blade members of each of the vertical blade assemblies 6.

In addition, as shown in FIG. 8, the air-conditioning register according to Example No. 3 further comprises two vertical-blade-assembly operation units 8 for controlling the swing direction of the vertical blade members of each of the vertical blade assemblies 6. As shown in the drawing, the vertical-blade-assembly operation unit 8 comprises an operation knob 80, and a connector 81. The operation knob 80 is disposed under the outlet opening 10 of the register panel 1, projects outward into a vehicle passenger room, and has an operation stud 800. The connector 81 connects the operation knob 80 with the swing shafts of the vertical blade members of each of the vertical blade assemblies 6. The operation knob 80 is supported swingably to the retainer 2. Specifically, the operation knob 80 can swing about the leading-end side, which is placed more forward than the leading ends of the top-surface wall 210 and bottom-surface wall 220 of the retainer 2 are placed. Moreover, the operation knob 80 further has a connector shaft 801. The connector shaft 801 is disposed more rearward to the base or inner opposite of the operation knob 80 than the swing center thereof is placed, and is connected with the connector 81 at the base or inner opposite end. The connector 81 connects the operation knob 80 with the swing shafts of the vertical blade members of each of the vertical blade assemblies 6. Accordingly, when an operator manipulates the operation knob 80, the base or inner opposite end of the connector shaft 801 swings about the swing center in the peripheral direction. The connector 81 transmits the swinging movement of the connector shaft 801's base or inner opposite end to the swing centers of the vertical blade members of each of the vertical blade assemblies 6. Consequently, the vertical blade members swing.

The two dampers 7 comprise a damper body 70, and a damper operation unit for operating the damper body 70, respectively. As shown in FIG. 7, the damper body 70 is disposed in each of the retainers 2. Specifically, the damper body 70 is supported and accommodated swingably in the ventilation passage within the retainer 2, and is formed as a plate shape so that it can shut off the ventilation passage within the retainer 2. Moreover, the damper body 70 is disposed swingably about the width-wise middle as the swing center, and is assembled swingably with the paired side walls of each of the retainers 2 at the length-wise opposite ends.

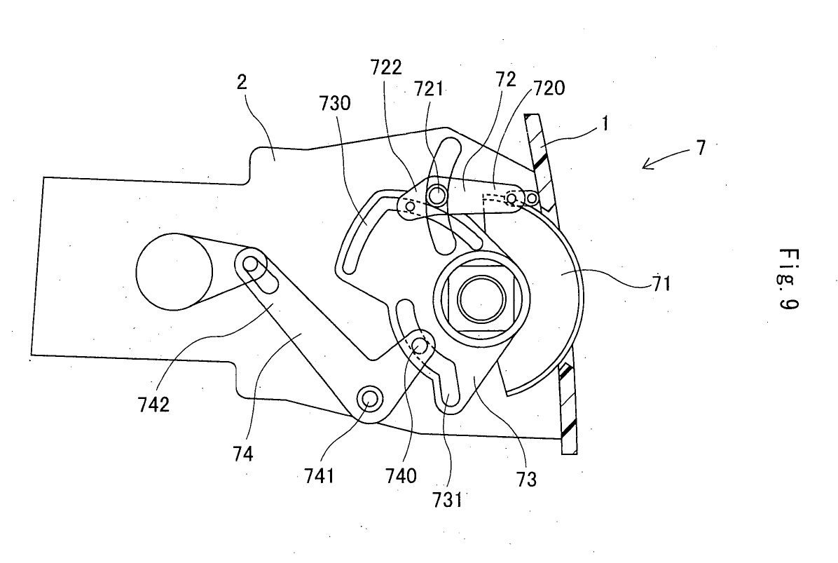

As shown in FIG. 9, the damper operation unit comprises an operation knob 71, and a link mechanism. The operation knob 71 is disposed on one of the opposite sides of the outlet opening 10 in the register panel 1, and has an operation dial, part of which projects outward into a vehicle passenger room. The link mechanism connects the operation knob 71 to the swing shaft of the each of the damper bodies 70. Specifically, the operation knob 71 is formed as a substantially-sector-shaped disk whose outer periphery protrudes outward into a vehicle passenger room in the peripheral direction. Moreover, the operation knob 71 is held to one of the paired side walls of each of the retainers 2 so as to be swingably about the center of the sector shape in the peripheral direction, as shown in FIG. 9.

Moreover, as shown in FIG. 9, the link mechanism comprises a first link 72, a second link 73, and a third link 74. The first link 72 is held swingably to the outer periphery of the operation knob 71 at one of the opposite ends, an opposite end 720, and has a swing shaft 721, which is supported pivotably to the retainer 2. The second link 73 is formed as a substantially plate shape, is disposed coaxially and swingably to the swing shaft of the operation knob 71, and has a first groove 730, which guides the other opposite ends of the first link 72, an opposite end 722 thereof, and a second groove 731. The third link 74 is formed as a plate shape substantially, and has a swing shaft 741, an opposite end 740 and another opposite end 742. The swing shaft 741 is supported pivotably to each of the retainers 2, the opposite end 740 is guided by the second groove 731 of the second link 73, and the other opposite end 742 is connected swingably to the swing shaft of each of the damper bodies 70. Note that the first guide groove 730 and second guide groove 731, which are formed in the second link 73, are formed as a substantially dog-leg shape, respectively, so that the damper bodies 70 can control the opening magnitude of the ventilation passages within the retainer 2.

An operator manipulates each of the dampers 7 in the following manner. When an operator manipulates the operation dial of the operation knob 71, which projects outward into a vehicle passenger room, to swing the operation knob 71, the swinging operation knob 71 moves one of the opposite ends of the first link 72, the opposite end 720 thereof, in the peripheral direction to swing the first link 72 about the swing shaft 721. When the first link 72 swings, the other opposite end 722 of the first link 72 and the first guide groove 730 interact to swing the second link 73. When the second link 73 swings, the second guide groove 731 of the second link 73 and one of the opposite ends of the third link 74, the opposite end 740 thereof, interact to swing the third link 74 about the swing shaft 741. When the third link 74 swings, the other one of the opposite ends of the third link 74, the opposite end 742 thereof, which is connected swingably to the swing shaft of each of the damper bodies 70, moves to swing the damper bodies 70, respectively. Thus, an operator can adjust the opening magnitude of the ventilation passage within each of the retainers 2 to desired opening magnitudes by swinging each of the damper bodies 70.

The air-conditioning register according to Example No. 3 differs from the air-conditioning register according to Example No. 1 only in that the vertical-blade-assembly operation unit for operating the vertical blade assembly 6 is arranged differently from the vertical-blade-assembly operation knob 41 in Example No. 1. Accordingly, the air-conditioning register according to Example No. 3 demonstrates the same advantages in the same manner as the air-conditioning register according to Example No. 1.

### Modified Versions

In the air-conditioning registers according to Example Nos. 1, 2 and 3, the top-surface wall 210 and bottom-surface wall 220 are arranged so that they are driven by the horizontal blade 3. However, the paired leading side-surface walls of the retainer 2 can be driven by the vertical blade assembly 4, 5 or 6. Moreover, the top-surface wall, bottom-surface wall and paired side-surface walls can be driven by the horizontal blade 3 or the vertical blade assembly 4, 5 and 6, respectively.

Moreover, the top connector 211 and bottom connector 221, which connect the top-surface wall 210 and bottom-surface wall 220 with the retainer body 20, can be arranged differently so that they can connect the top-surface wall 210 and bottom-surface wall 220 with the retainer body 20 in such a manner that they keep the cylinder shape of the retainer 2 demarcating the ventilation passage. To put it differently, the top connector 211 and bottom connector 221 can comprise a bellows-shaped cylindrical member, which exhibits flexibility, respectively, for instance.

The thus modified present air-conditioning registers can control so as to direct the ventilation passage in desired directions adjacent to the outlet opening 10 of the register panel 1 within the retainer 2 so that they can demonstrate the same advantages as those produced by the air-conditioning registers according to Example Nos. 1, 2 and 3.

Having now fully described the present invention, it will be apparent to one of ordinary skill in the art that many changes and modifications can be made thereto without departing from the spirit or scope of the present invention as set forth herein including the appended claims.

What is claimed is:

1. A register for air conditioning, comprising:
a register panel disposed in a vehicle passenger room, and having an outlet opening for air-conditioning air; and
a cylinder-shaped retainer demarcating a ventilation passage communicated with the outlet opening of the register panel, and having an inner opposite end and a register-panel-side opposite end;
the register-panel-side opposite end comprising at least one member selected from the group consisting of:
a top-surface wall demarcating a top surface of the ventilation passage, and disposed movably so as to make the top surface movable between diminishing the ventilation passage and enlarging the ventilation passage adjacent to the outlet opening of the register panel;
a bottom-surface wall demarcating a bottom surface of the ventilation passage, and disposed movably so as to make the bottom surface movable between diminishing the ventilation passage and enlarging the ventilation passage adjacent to the outlet opening of the register panel; and
paired side-surface walls demarcating paired side surfaces of the ventilation passage, and disposed movably so as to make the paired side surfaces movable between diminishing the ventilation passage and enlarging the ventilation passage adjacent to the outlet opening of the register panel.

2. The register set forth in claim 1, wherein:
at least one of the top-surface wall, the bottom-surface wall and the paired side-surface walls is formed as a plate shape, and is supported swingably about the register-panel-side opposite end.

3. The register set forth in claim 1, wherein the retainer comprises the top-surface wall, and the bottom-surface wall.

4. The register set forth in claim 3, wherein:
the bottom-surface wall moves so as to enlarge the ventilation passage when the top-surface wall moves to diminish the ventilation passage; and
the bottom-surface wall moves so as to diminish the ventilation passage when the top-surface wall moves to enlarge the ventilation passage.

5. The register set forth in claim 1 further comprising at least one member selected from the group consisting of:
a vertical blade supported and accommodated swingably in the retainer, and making a flowing direction of the air-conditioning air adjustable laterally; and
a horizontal blade supported and accommodated swingably in the retainer, and making a flowing direction of the air-conditioning air adjustable longitudinally.

6. The register set forth in claim 1, wherein at least one of the top-surface wall, the bottom-surface wall and the paired side-surface walls comprises:
a wall member demarcating a surface of the ventilation passage within the retainer, having a leading opposite end and a trailing opposite end, and held swingably to the retainer at the leading opposite end; and
a connector member demarcating a surface of the ventilation passage within the retainer, having leading opposite end and a trailing opposite end, held swingably to the wall member at the leading opposite end, and held reciprocally to the retainer at the trailing opposite end.

7. The register set forth in claim 1, wherein the retainer comprises:
a plate-shaped wall making at least one of the top-surface wall, the bottom-surface wall and the paired side-surface walls;
a cylinder-shaped retainer body; and
a connector demarcating a part of the ventilation passage in the retainer, and connecting the retainer body with at least one of the top-surface wall, the bottom-surface wall and the paired side-surface walls.

8. The register set forth in claim 1, wherein the register-panel-side opposite end is formed as a shape which agrees with the outlet opening of the register panel.
